(19) United States
(12) Patent Application Publication
(10) Pub. No.: US 2014/0258834 A1
(43) Pub. Date: Sep. 11, 2014

(54) Systems and Methods for Displaying Content with Inline Advertising Zones

(71) Applicant: SAY MEDIA, INC., San Francisco, CA (US)

(72) Inventor: Darrick Paul Brown, Redwood City, CA (US)

(73) Assignee: Say Media, Inc., San Francisco, CA (US)

(21) Appl. No.: 13/793,751

(22) Filed: Mar. 11, 2013

(51) Int. Cl. G06F 17/22

(52) U.S. Cl. CPC G06F 17/2247
USPC 715/234

(57) ABSTRACT

Systems and methods for content display devices configured to display content with inline advertising zones in accordance with embodiments of the invention are disclosed. In one embodiment, a content display device includes a processor, a content display application, wherein the content display application configures the processor to receive web page data including a plurality of pieces of content data and at least one script, receive advertising content, generate an object model using the web page data, render the received web page data including displayable content and an inline advertising zone, display a portion of the rendered web page data, receive input, display a second portion of the rendered web page data, identify when the inline advertising zone is within the inline advertising zone threshold, modify the object model to include the advertising content in the displayed content based on the inline advertising zone, and re-render the received web page data.

### FIELD OF THE INVENTION

The present invention relates to systems and methods for displaying content using content display devices and more specifically to displaying content with inline advertising zones.

### BACKGROUND

The Internet is a global system of interconnected computer networks. A variety of services are provided on the Internet, including websites. Websites include a variety of content, such as text, pictures, audio data, video data, and other interactive content. Web sites are typically hosted using content servers and a web browser is an application that enables a user to receive, view, and interact with a websites hosted on content servers. A variety of web browsers are commonly used to view websites, including Internet Explorer from Microsoft Corporation of Redmond, Wash. and the Chrome browser from Google, Inc. of Mountain View, Calif.

Many documents, including web pages within a website, are often written using the Hypertext Markup Language (HTML). A HTML document contains a set of nested tags. HTML tags include data stored in the tag, either as a property of the tag or between an opening tag and a closing tag. Web browsers do not display the HTML tags; rather, web browsers are configured to parse a HTML document and render one or more web pages including the information stored in the HTML tags.

Cascading Style Sheets (CSS) are used to describe the formatting and display of a document when it is rendered. CSS can be used to describe the formatting of a variety of documents, including HTML documents and other documents, such as documents written using the Extensible Markup Language (XML). A single document can have a variety of associated CSS, so that the document can be rendered in a variety of ways depending on the capabilities of the device used to display the document. For example, a HTML document can be rendered with one format in a web browser on a desktop computer using a CSS designed for a desktop browser, while the same HTML document can be rendered in a second format in a web browser running on a mobile phone using a second CSS designed for a mobile browser.

The Document Object Model (DOM) is a standard defined by the Word Wide Web Consortium that defines the creation of an in-memory object model corresponding to data contained in documents, including HTML and XML documents. These objects are stored in a DOM tree and are utilized by web browsers to render and manipulate documents. When a HTML document is rendered in a web browser, the browser parses the HTML and creates an in-memory DOM that is used to display the HTML document. Web browsers contain one or more layout engines configured to create a DOM from a document. Many layout engines are used today, including the open-source WebKit layout engine utilized by the Chrome browser and the Apple Safari browser from Apple, Inc. of Cupertino, Calif. and the Trident layout engine used in Internet Explorer.

Many web pages utilize scripts in order to provide flexibility in the creation and display of a web page. Scripts can be written in a variety of languages, including JavaScript by the Mozilla Foundation of Mountain View, Calif. and ECMAScript, standardized as ECMA-262 by ECMA International of Geneva, Switzerland. Web browsers are configured to parse and execute scripts contained in web pages. These scripts can control the appearance of a web page, customize the content according to the preferences of a user viewing the web page, and allow for data to be received using the web page. Scripts can be server-side, where the script is run on a content server, or client-side, where the script is run using the web browser receiving the script.

### SUMMARY OF THE INVENTION

Systems and methods for content display devices configured to display content with inline advertising zones in accordance with embodiments of the invention are disclosed. In one embodiment, a content display device includes a processor, memory connected to the processor and configured to store a content display application, a network interface connected to the processor and configured to receive web page data, an input device connected to the processor and configured to receive input data, and a display connected to the processor and configured to display content, wherein the content display application configures the processor to receive web page data using the network interface, where the web page data includes a plurality of pieces of content data and at least one script, receive advertising content using the network interface, generate an object model using the web page data, render the received web page data using the object model, where the rendered web page data includes displayable content and an inline advertising zone within the displayable content, where the inline advertising zone includes an inline advertising zone threshold, display a portion of the rendered web page data using the display, receive input using the input device, display a second portion of the rendered web page data using the display based on the received input, identify when the inline advertising zone is within the inline advertising zone threshold using at least one of the at least one script, where the advertising zone threshold is based on the position of the inline advertising zone within the displayed portion of the rendered web page data, modify the object model to include the advertising content in the displayed content based on the inline advertising zone, and re-render the received web page data using the updated object model, where the re-rendered web page data includes the advertising content, and display the re-rendered web page data using the display.

In an additional embodiment of the invention, the advertising content includes an inline interstitial advertisement, where an inline interstitial advertisement is configured to occupy the display of the content display device in a manner such that the inline interstitial advertisement is the focal point of the rendered web page data and the remaining content is de-emphasized from view.

In another embodiment of the invention, the content display application further configures the processor to receive advertising content from an advertising source separate and remote from the content display device.

In yet another additional embodiment of the invention, the content display application further configures the processor to display an advertising placeholder associated with the inline advertising zone, where the advertising placeholder is configured to provide an indication that advertising content will be displayed.

In still another additional embodiment of the invention, the advertising placeholder includes the received advertising content.

In yet still another additional embodiment of the invention, the content display application further configures the processor to request additional content from a content source separate and remote from the content display device, receive the additional content from the content source, modify the object model to incorporate the received additional content, re-render the received web page data using the modified object model, and display the re-rendered web page data including the additional content.

In yet another embodiment of the invention, the content display application further configures the processor to generate input metadata based on the received input, determine if an advertising threshold is reached based on the input metadata, and inject an additional inline advertising zone into the object model based on the generated input metadata when the advertising threshold is reached.

In still another embodiment of the invention, the input metadata is based on the time associated with identifying when the inline advertising zone is within the inline advertising zone threshold and the content display application further configures the processor to determine the time elapsed between the request for additional content and the recorded time and inject the additional inline advertising zone based on the determined time elapsed.

In yet still another embodiment of the invention, the input metadata is based on the number of requests for additional content and the content display application further configures the processor to inject the additional inline advertising zone based on the number of requests for additional content.

In yet another additional embodiment of the invention, the content display application further configures the processor to measure the time elapsed since the re-rendered web page data was displayed and receive additional input using the input device when the measured time elapsed exceeds a time threshold associated with the advertising content, where the time threshold indicates a minimum amount of time the advertising content should be displayed using the display device.

Yet another embodiment of the invention includes a method for displaying content having inline advertising zones, including receiving web page data using a content display device, where the web page data includes a plurality of pieces of content data, at least one inline advertising zone, and at least one script, where the inline advertising zone includes an inline advertising zone threshold, receiving advertising content using the content display device, generating an object model based on the web page data using the content display device, rendering the received web page data based on the object model using the content display device, where the rendered web page data includes displayable content and an inline advertising zone within the displayable content, displaying a portion of the rendered web page data using the content display device, receiving input using the content display device, displaying a second portion of the rendered web page data using the content display device based on the received input, identifying when the inline advertising zone is within the inline advertising zone threshold based at least one of the at least one script using the content display device, where the advertising zone threshold is based on the position of the inline advertising zone within the displayed portion of the rendered web page data, modifying the object model to include the advertising content in the displayed content based on the inline advertising zone using the content display device, re-rendering the received web page data based on the updated object model using the content display device, where the re-rendered web page data includes the advertising content, and displaying the re-rendered web page data using the content display device.

In yet another additional embodiment of the invention, the advertising content includes an inline interstitial advertisement, where an inline interstitial advertisement is configured to occupy the display of the content display device in a manner such that the inline interstitial advertisement is the focal point of the rendered web page data and the remaining content is de-emphasized from view.

In still another additional embodiment of the invention, displaying content having inline advertising zones further includes receiving advertising content from an advertising source separate and remote from the content display device using the content display device.

In yet still another additional embodiment of the invention, displaying content having inline advertising zones further includes displaying an advertising placeholder associated with the inline advertising zone using the content display device, where the advertising placeholder is configured to provide an indication that advertising content will be displayed.

In yet another embodiment of the invention, the advertising placeholder includes the received advertising content.

In still another embodiment of the invention, displaying content having inline advertising zones further includes requesting additional content from a content source separate and remote from the content display device using the content display device, receiving the additional content from the content source using the content display device, modifying the object model to incorporate the received additional content using the content display device, re-rendering the received web page data based the modified object model using the content display device, and displaying the re-rendered web page data including the additional content using the content display device.

In yet still another embodiment of the invention, displaying content having inline advertising zones further includes generating input metadata based on the received input using the content display device, determining if an advertising threshold is reached based on the input metadata using the content display device, and injecting an additional inline advertising zone into the object model based on the generated input metadata when the advertising threshold is reached using the content display device.

In yet another additional embodiment of the invention, displaying content having inline advertising zones further includes determining the time elapsed between the request for additional content and the recorded time using the content display device, where the input metadata is based on the time associated with identifying when the inline advertising zone is within the inline advertising zone threshold and injecting the additional inline advertising zone based on the determined time elapsed using the content display device.

In still another additional embodiment of the invention, displaying content having inline advertising zones further includes injecting the additional inline advertising zone based on the number of requests for additional content using the content display device, where the input metadata is based on the number of requests for additional content.

In yet still another additional embodiment of the invention, displaying content having inline advertising zones further includes measuring the time elapsed since the re-rendered web page data was displayed using the content display device and receiving additional input using the content display device when the measured time elapsed exceeds a time threshold associated with the advertising content, where the time threshold indicates a minimum amount of time the advertising content should be displayed using the display device.

### BRIEF DESCRIPTION OF THE DRAWINGS

FIG. 1 conceptually illustrates a content display system in accordance with an embodiment of the invention.

FIG. 2 is a conceptual illustration of a content display device configured to display content with inline advertising zones in accordance with an embodiment of the invention.

FIG. 3 is a flow chart illustrating a process for receiving and displaying content with inline advertising zones in accordance with an embodiment of the invention.

FIG. 4 is a flow chart illustrating a process for displaying advertising content in inline advertising zones in accordance with an embodiment of the invention.

FIG. 5 is a flow chart illustrating a process for injecting inline advertising zones into displayed content in accordance with an embodiment of the invention.

### DETAILED DESCRIPTION

Turning now to the drawings, systems and methods for displaying content with inline advertising zones in accordance with embodiments of the invention are illustrated. When displaying content (such as web pages), web browsers receive input, including scrolling input in a vertical and/or horizontal direction, to control which portion of the content is displayed. This input is mapped to actions or events that are generated by a web browser or the operating system of a content display device. For example, in many embodiments of the invention, an input representative of a horizontal input causes a horizontal input event to be generated by the operating system of the content display device; the web browser receives the horizontal input event and executes a corresponding method to horizontally move the content rendered in the web browser.

Content display devices in accordance with embodiments of the invention are configured to display content, such as web pages, having one or more inline advertising zones within the content. Content display devices are configured to map the received input to the displayed content to enable various portions of the content to be displayed. In several embodiments, the web page contains a script configured to map the input received using the web browser to manipulate the content in the web page. Inline advertisement zones in accordance with a variety of embodiments of the invention include inline advertising zone thresholds describing when the advertising content associated with the inline advertising zone should be displayed. In many embodiments, inline advertising zones include an advertising placeholder indicating that an advertisement will be displayed when the inline advertising zone reaches a particular portion of the displayed content. When an inline advertising zone is displayed and the advertising zone threshold is reached, one or more scripts in the web page are configured to automatically position the content such that the inline advertising zone is located within the viewable area of the content display device. In several embodiments, the scripts are configured to retrieve and insert advertising content into the displayed content once the inline advertising zone reaches a particular portion of the viewable area of a display associated with the content display device. In many embodiments, at least one script in the web page is configured to dynamically resize the content depending on the advertising content contained in the inline advertising zone. The display of the advertisement within the inline advertising zone can include a portion of the displayed content and/or can be dynamically configured to hide the content in the web page aside from the content within the inline advertising zone; in this manner, only the advertising content is displayed once the inline advertising zone is brought into view. In a variety of embodiments, advertising content includes an inline interstitial advertisement. In several embodiments, an inline interstitial advertisement is advertising content that occupies the display of the content display device in a manner such that the inline interstitial advertisement is the focal point of the web page and the remaining content is obscured and/or otherwise de-emphasized from view. Inline interstitial ads can include links or other functionality to cause the remaining content to return to view; however, in many embodiments inline interstitial ads are configured to be incorporated into the displayed content and move along with the displayed content. As additional input is mapped to the displayed content, the advertisement moves along with the content being displayed. In many embodiments, once the advertisement is displayed within the inline advertising zone, the advertisement becomes a portion of the content. In a number of embodiments, the inline advertising zone and/or the advertising placeholder is removed from the content once it has been displayed.

In several embodiments, a content display device is configured to receive additional content and display the additional content as part of the content displayed. In a variety of embodiments, content display devices are configured to track the received input and inject inline advertising zones into the additional content being added to the displayed content. The inline advertising zones can be injected based upon a variety of advertising thresholds or other factors, including the tracked input, the time between displayed advertising content, the amount of advertising previously displayed, the amount of additional content incorporated into the displayed content, and a variety of other advertising thresholds as appropriate to the requirements of specific applications in accordance with embodiments of the invention.

Content display devices include computers running web browsers configured to display hypertext markup language (HTML) web pages using cascading style sheets (CSS) and one or more scripts using a document object model (DOM) representing the web page. In a number of embodiments, the CSS are used to define the HTML defining the web page and the CSS are utilized to define and style the content and/or the inline advertising zones. In a number of embodiments, the scripts are configured to modify the content of the web page/and or directly modify the DOM model representing the web page in the web browser. These scripts can be contained in one or more files included in the web page and/or included inline in the web page. The scripts can be written in any scripting language known to one of ordinary skill in the art including, but not limited to, JavaScript and ECMAScript.

Although content display devices are described above with respect to HTML, CSS, and JavaScript, any variety of techniques can be utilized in accordance with embodiments of the invention. Systems and methods for displaying content with inline advertising zones in accordance with embodiments of the invention are described below.

### Content Display System Overview

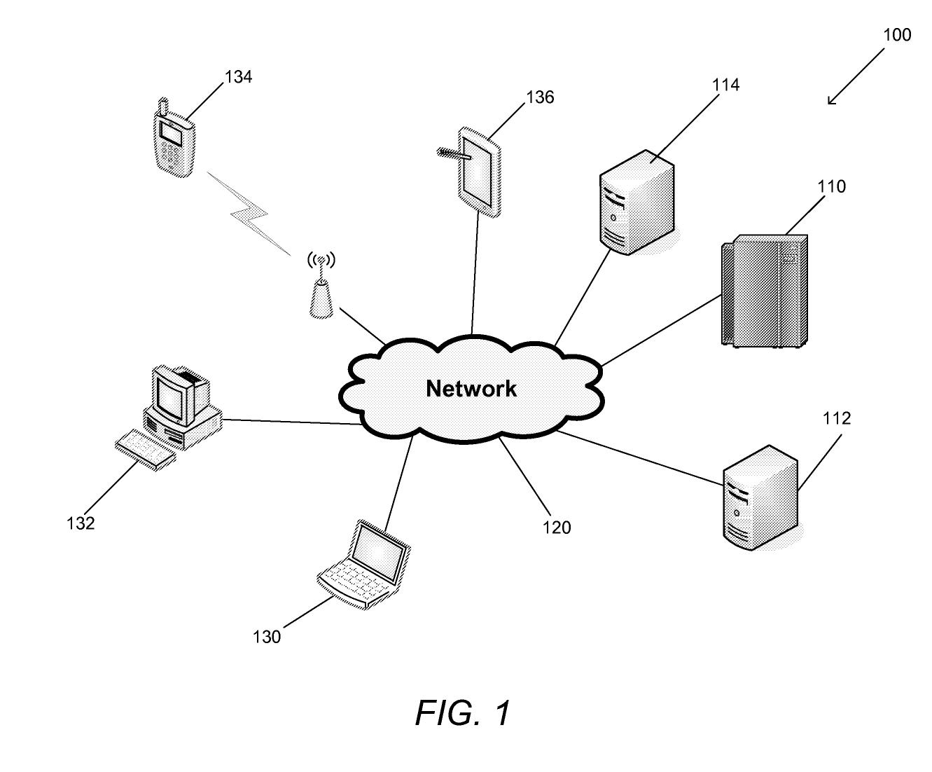

Content display systems in accordance with embodiments of the invention enable content display devices to receive content with inline advertising zones and display the received content from a variety of content sources. A content display system in accordance with an embodiment of the invention is illustrated in FIG. 1. The content display system 100 includes a content server 110 connected to one or more content display devices via a network 120. The content display system 100 also contains a content source 112 configured to provide content to the content server 110 and/or the content display devices along with an advertising source 114 configured to provide advertising data, including inline interstitial advertisements, to the content server 110 and/or the content display devices. The content devices include, but are not limited to, laptop computers 130, personal computers 132, cellular telephones 134, and tablet devices 136.

In many embodiments, the content server 110 is configured to receive additional content from the content source 112 and/or advertising content the advertising source 114 for inclusion in content to be sent to one or more content display devices. In a variety of embodiments, the content display devices are configured to request and/or receive additional content from the content source 112 and/or advertising content from the advertising source 114. In several embodiments, the content server 110, the content source 112, and/or the advertisement source 114 are implemented using a single server. In a number of embodiments, the content server 110, the content source 112, and/or the advertisement source 114 are implemented using a plurality of servers. The content source 112 and the advertising source 114 can be two discrete data sources or the same system as appropriate to the requirements of specific applications in accordance with embodiments of the invention. In many embodiments, the network 120 is the Internet.

The content display devices are configured to receive content having one or more inline advertising zones from the content server 110, to request and/or receive additional content from the content source 112, and/or request and/or receive advertising content from the advertising source 114. In a variety of embodiments, the content contains at least one script describing the manner in which interactions with the content and the inline advertising zones affect the display of the content and the inline advertising zones using the content display device. Interactions include, but are not limited to, scrolling events and mouse clicks as appropriate to the requirements of specific applications in accordance with embodiments of the invention. In many embodiments, the display of the content, advertising placeholders associated with an inline advertising zone, and/or advertising content is based on the capabilities of the content display device.

In a variety of embodiments, one or more of the inline advertising zones in the received content can be populated with content received from the content server 110, additional content received from the content source 112, and/or advertising content received from the advertising source 114. In several embodiments, the content display devices are configured to dynamically resize an inline advertising zone depending on the received advertising content that is used to populate the inline advertising zone. In a number of embodiments, the content and/or the advertising content are a web page (or a portion of a web page) including HTML elements, CSS, and scripts and the content display devices are configured to render the received web page. In many embodiments, a content display device creates an in-memory object model as part of the rendering of the received web page. In a variety of embodiments, the content display devices are configured to display advertising content associated with inline advertising zones and/or add additional content to the web page by modifying the in-memory object model and/or the actual received web page. Content display devices in accordance with embodiments of the invention are configured to receive input for navigating and/or manipulating the rendered web page (and included advertising content) and to dynamically render the advertising content and/or inline advertising zones contained in the web page based on the received input. In a variety of embodiments, the content display devices are configured to interrupt the mapping of the received input to the displayed content when an inline advertising zone and/or advertising content associated with the inline advertising zone is displayed.

Although a specific content display system is conceptually illustrated in FIG. 1, alternative architectures, including those with content display devices in peer-to-peer communication, can also be utilized in accordance with embodiments of the invention. Systems and methods for content display devices and content having inline advertising zones in accordance with embodiments of the invention are discussed below.

### Content Display Devices

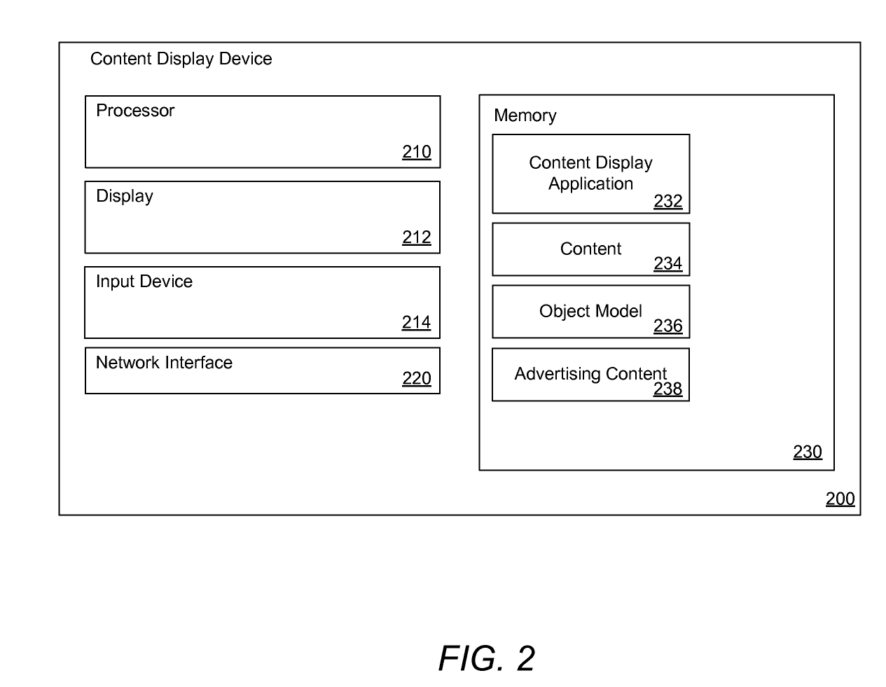

Content display devices in accordance with embodiments of the invention are configured to render content having inline advertising zones, allow for interaction with the rendered content, and display advertising in the inline advertising zones in response to interactions with the rendered content. A conceptual illustration of a content display device in accordance with an embodiment of the invention is shown in FIG. 2. The content display device 200 includes a processor 210 in communication with memory 230. The content display device 200 also includes a network interface 220 configured to send and receive data over a network connection. In a number of embodiments, the network interface 220 is in communication with the processor 210 and the memory 230.

The content device 200 includes a display 212 and an input device 214 connected to the processor 210. The processor 210 is configured by the content display application 232 to render content 234 having one or more inline advertising zones for display using the display 212. The content display application 232 configures the processor 210 to display advertising content 238 when the inline advertising zone and/or an advertising placeholder is displayed. Displaying the advertising content 238 can include automatically scrolling and/or obscuring the displayed content based on one or more scripts included in the content 234. In several embodiments, the content display application 232 configures the processor 210 to generate an in-memory object model 236 representing the content 234 and the advertising content 238 and render the content for display via the display 212 using the in-memory object model 236. Additionally, the content display application 232 configures the processor 210 to dynamically resize the displayed content and/or modify the object model 236 based on the advertising content 238. The processor 210 is configured to receive input for displaying and navigating the rendered content using the input device 214. The content display application 232 configures the processor 210 to map the received input to the rendered content to display portions of the displayed content. Upon the display of an inline advertising zone, the content display application 232 configures the processor 210 to retrieve, render, and/or display the advertising content associated with the inline advertising zone. In a variety of embodiment, the content display application 232 configures the processor 210 to interrupt the mapping of the received input to the displayed content when the advertising content is displayed. In a number of embodiments, the content display application 232 configures the processor 210 to tailor the rendering of the displayed content to the capabilities of the content display device based on the processor 210, the content display application 232, the display 212, the input device 214, the content 234, and/or the advertising content 238. In many embodiments, the display 212 is a monitor, cell phone display, or other device capable of displaying content. In several embodiments, the input device 214 is one or more of a variety of devices, including, but not limited to, mice, keyboards, touch screens, and cameras configured to track movement.

In several embodiments, the memory 230 is any form of storage configured to store a variety of data, including, but not limited to, a content display application 232, content 234, one or more object models 236, and advertising content 238. The content display application 232 configures the processor 210 to retrieve the content 234, the object model 236, and/or the advertising content 238 for rendering and display and to store generated in-memory data models of web pages and/or the retrieved content for storage and later retrieval.

The network interface 220 is configured to receive content 234 having inline advertising zones, advertising content 238, and additional content from a variety of sources, including, but not limited to, content sources and advertising sources via a network (such as the Internet) and provide the received content to the processor 210 and/or the memory 230. The content display application 232 configures the processor 210 to generate requests for content having inline advertising zones, advertising content, and/or additional content and transmit those requests using the network interface 220. In many embodiments, the content display application 232, the content 234, the object model 236, and/or the advertising content 238 are stored using an external server system and received by the content display device 200 using the network interface 220.

Although a specific architecture for a content display device in accordance with an embodiment of the invention is conceptually illustrated in FIG. 2, any of a variety of architectures, including those which store data or applications on disk or some other form of storage and are loaded into memory 230 at runtime and systems that are distributed across multiple physical servers, can also be utilized in accordance with embodiments of the invention. Methods for displaying content with inline advertising zones in accordance with embodiments of the invention are discussed below.

Receiving and Rendering Content with Inline Advertising Zones

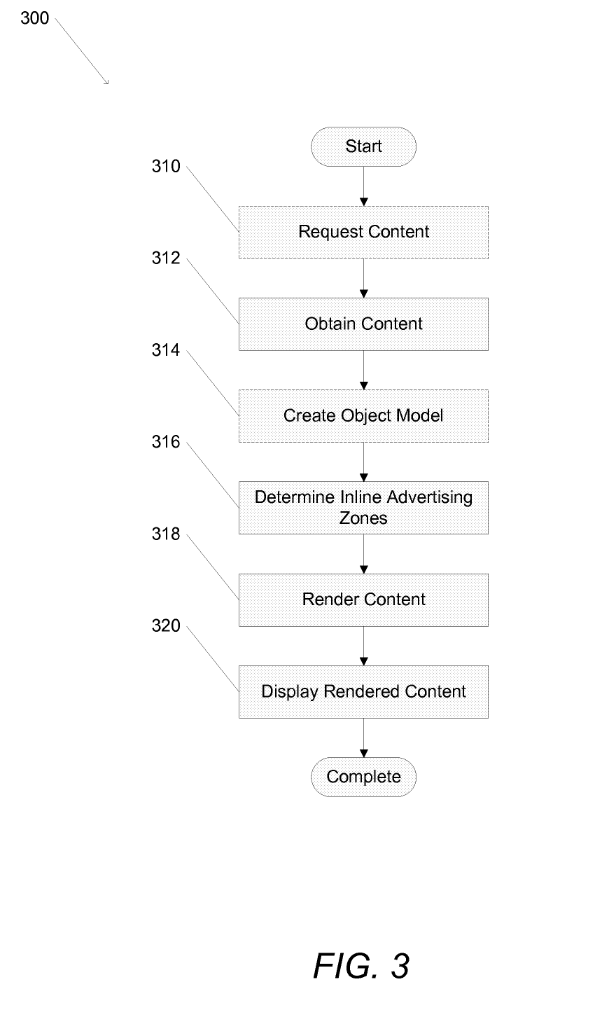

Using inline advertising zones, advertising content can be displayed in a manner integrated with the consumption of the content. A variety of advertising content, including interstitial advertisements, can be presented to a user without interrupting a user's consumption of the content. After the advertisement has been displayed, the user can continue browsing the content with the advertisement incorporated into the content. Content display devices in accordance with embodiments of the invention are configured to receive and display content having inline advertising zones and display advertising content associated with the inline advertising zones. A process for receiving and displaying content with inline advertising zones in accordance with an embodiment of the invention is illustrated in FIG. 3. In many embodiments, the process 300 includes requesting (310) content including inline advertising zones. Content including inline advertising zones is obtained (312). In many embodiments, an in-memory object model is created (314). Advertising locations are determined (316). The content is rendered (318) and displayed (320).

In many embodiments, requesting (310) and/or obtaining (312) content with inline advertising zones utilizes the hypertext transfer protocol (HTTP) and/or a secured version of HTTP, such as HTTP Secure. HTTP is defined in RFC 2616, published by the Internet Engineering Task Force, the entirety of which is incorporated by reference. In other embodiments, any of a variety of stateless and/or stateful data transfer protocols can be utilized. In several embodiments, the obtained (312) content with inline advertising zones is a web page containing HTML, CSS, and/or one or more scripts. The positions of the inline advertising zone(s) can be indicated within the obtained (312) content and/or within one or more of the scripts associated with the obtained (312) content. In addition, other techniques for identifying the position of inline advertising zones within content can be utilized as appropriate to the requirements of specific applications in accordance with embodiments of the invention. In a number of embodiments, receiving (312) content further includes receiving additional content and/or advertising content referenced in inline advertising zones in the obtained (312) content. In many embodiments, the in-memory object model created (314) is a DOM.

In many embodiments, determining (316) inline advertising zones includes identifying markup in the obtained (312) content. A variety of markup can be utilized as appropriate to the requirements of specific applications in accordance with embodiments of the invention, including, but not limited to, <div> tags and/or custom HTML tags. In a number of embodiments, the obtained (312) content does not include an inline advertising zone and determining (316) inline advertising zones includes dynamically incorporating one or more inline advertising zones into the obtained (312) content and/or the created (314) object model. In a variety of embodiments, the obtained (312) content has a width and a height and determining (316) inline advertising zone(s) includes associating advertising zone thresholds with one or more vertical and/or horizontal positions within the content based on the width and/or height of the content. In several embodiments, rendering (318) the content utilizes the obtained (312) content and/or the created (314) in-memory object model. In a variety of embodiments, the content is displayed (320) utilizing a display device connected to a content display device. In many embodiments, displaying (320) the content includes displaying an advertising indicator representing the location of an inline advertising zone and/or an inline advertising zone threshold within the displayed (320) content. In several embodiments, the displayed (320) content is based on the capabilities of the content display device displaying (320) the content. Capabilities of a content display device include, but are not limited to, the resolution of the display associated with the content display device, the web browser or other content display application utilized by the content display device to display the content, and/or the processing capabilities of the content display device. Any capabilities of content display devices not specifically described can be utilized as appropriate to the requirements of specific applications in accordance with embodiments of the invention.

Although a specific process for receiving and rendering content with inline advertising zones where the content is a HTML web page is described above with respect to FIG. 3, any number of processes for rendering content with inline advertising zones, including content that is not a HTML web page, can be utilized in accordance with embodiments of the invention. Processes for displaying and injecting advertising content in content having inline advertising zones in accordance with embodiments of the invention are discussed below.

Displaying Advertisements Associated with Inline Advertising Zones

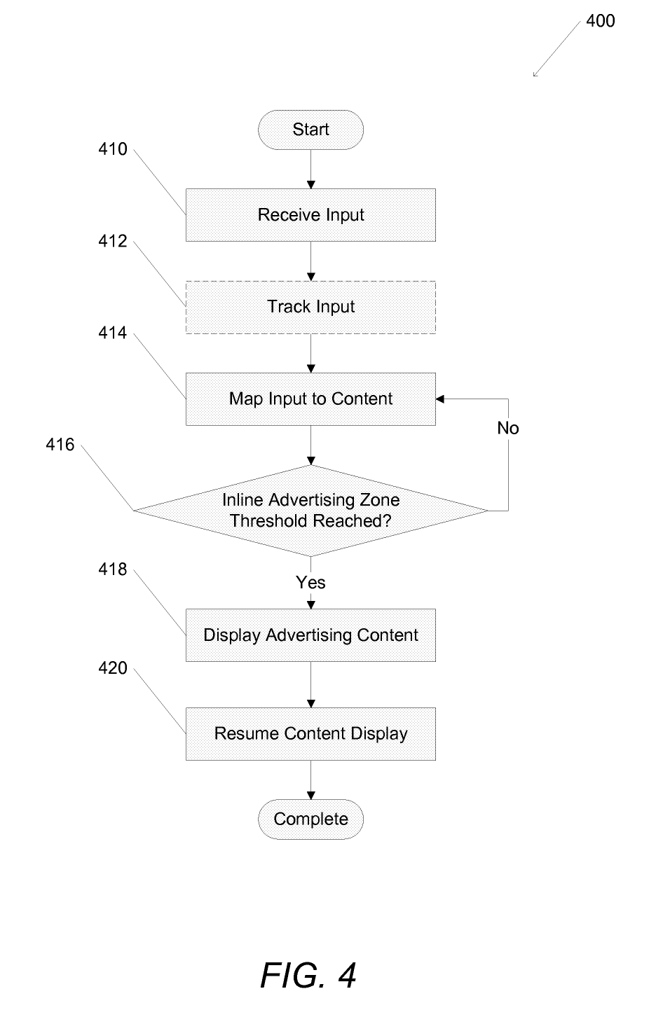

Content having inline advertising zones is configured to be rendered to display advertisement content when conditions associated with the inline advertising zones are met. This allows advertising content to be dynamically displayed during the consumption of the content based on interactions with the content. Content display devices in accordance with embodiments of the invention are configured to track the content being displayed and interactions with the displayed content and display advertising content associated with the inline advertising zones based on the tracked interactions and content. A process for displaying advertising content associated with inline advertising zones in accordance with embodiments of the invention is illustrated in FIG. 4. The process 400 includes receiving (410) input. In several embodiments, input is tracked (412). The received (410) input is mapped to the displayed content. When an inline advertising zone threshold is reached (416), the inline advertising zone is displayed (418). The display of content is resumed (420) following additional interaction(s).

In many embodiments, input is received (410) using an input device connected to a content display device. In a number of embodiments, tracking (412) input includes logging the nature, distance, and/or the direction the received (410) input. In many embodiments, the received (410) input is an event representing vertical and/or horizontal motion with respect to a web page displayed using a content display device. Systems and methods for tracking input and engagement with content that can be utilized in accordance with embodiments of the invention to track (412) input are described in U.S. patent application Ser. No. 13/792,855, titled “Systems and Methods for Categorizing and Measuring Engagement with Content” and filed Mar. 11, 2013, the disclosure of which is hereby incorporated by reference in its entirety. In several embodiments, the input is mapped (414) to the content using one or more scripts contained in the web page and/or via the software controlling the rendering and display of the displayed content. In a variety of embodiments, mapping (414) input to the displayed content is interrupted and/or paused when an inline advertising zone threshold is reached (416). In a number of embodiments, an advertising placeholder associated with the inline advertising zone is displayed in the displayed content based on the position of the inline advertising zone within the displayed content. In several embodiments, the advertising placeholder is modified and/or replaced with one more alternative advertising placeholders based on the mapped (414) input.

In many embodiments, determining if an inline advertising threshold is reached (416) includes determining which portion of the content and/or inline advertising zone is displayed and/or the relationship between the portion of the content currently displayed and the inline advertising zone. In several embodiments, an inline advertising zone is displayed using an advertising placeholder associated with the inline advertising zone and displayed along with the displayed content. In a variety of embodiments, determining if an inline advertising threshold is reached (416) includes determining if the inline advertising zone is within a threshold where the advertisement should be displayed. The threshold can be determined dynamically and/or predetermined. In many embodiments, if the threshold is met, input (414) is automatically provided by at least one script associated with the displayed content to move the displayed content into a position where the inline advertising zone displayed in full (416). In a number of embodiments, the inline advertising threshold is the portion of the inline advertising zone present in the displayed portion of the content. In several embodiments, the inline advertising threshold is the height of the inline advertising zone within the displayed portion of the content. Any inline advertising threshold can be utilized as appropriate to the requirements of specific applications in accordance with embodiments of the invention.

In a variety of embodiments, displaying (418) advertising includes replacing and/or expanding an advertising placeholder associated with an inline advertising zone with advertising content. Any advertising content, including inline interstitial advertisements, can be utilized as appropriate to the requirements of specific applications in accordance with embodiments of the invention. In many embodiments, the advertising content is tailored to the content display device based on the capabilities of the content display device. The displayed (418) advertising content can be included with content and/or be retrieved from an advertisement source when the inline advertising zone threshold is reached (416).

In several embodiments, displaying (418) advertising content associated with an inline advertising zone includes modifying the markup contained within the original source file downloaded by the web browser application corresponding to the inline advertising zone and/or modifying an in-memory object corresponding to the displayed content and/or the inline advertising zone using a script contained in the web page. In a number of embodiments, displaying (418) advertising content includes computing how the inline advertising zone will change based upon the received (410) input and the displayed (418) advertising content and redrawing the relevant portion of the displayed content. The redrawing can be implemented in a variety of ways, such as by using bitmap caching and only displaying the portion of the web page that is updated in response to the displayed (418) advertising content. In many embodiments, resuming (420) the display of content includes continuing mapping (414) input to the content. In a variety of embodiments, resuming (420) the display of the content includes receiving (410) input corresponding to the input mapped (414) to the content that causes the advertising content to be displayed. By way of example, if a user is scrolling through the content and an inline advertising zone threshold is reached (416) causing the advertising content associated with the inline advertising zone to be displayed (418), the user can continue their browsing experience by continuing to scroll through the content. Other techniques for resuming (420) the display of content can be utilized as appropriate to the requirements of specific applications in accordance with embodiments of the invention. In a number of embodiments, resuming (420) the display of content includes waiting for a period of time, such as a minimum time threshold, to display the advertising content and/or continuing the mapping (414) of input. Time thresholds can be described in advertisement metadata associated with the displayed (418) advertising content, in the content including the inline advertising zone, and/or in the scripts associated with the displayed content. Time thresholds can be determined dynamically and/or predetermined as appropriate to the requirements of specific applications in accordance with embodiments of the invention.

Although a specific process for displaying inline advertising zones is described above with respect to FIG. 4, any number of processes for displaying and interacting with content having inline advertising zones can be utilized in accordance with embodiments of the invention. Methods for injecting inline advertising zones into displayed content in accordance with embodiments of the invention are discussed further below.

### Injecting Inline Advertising Zones

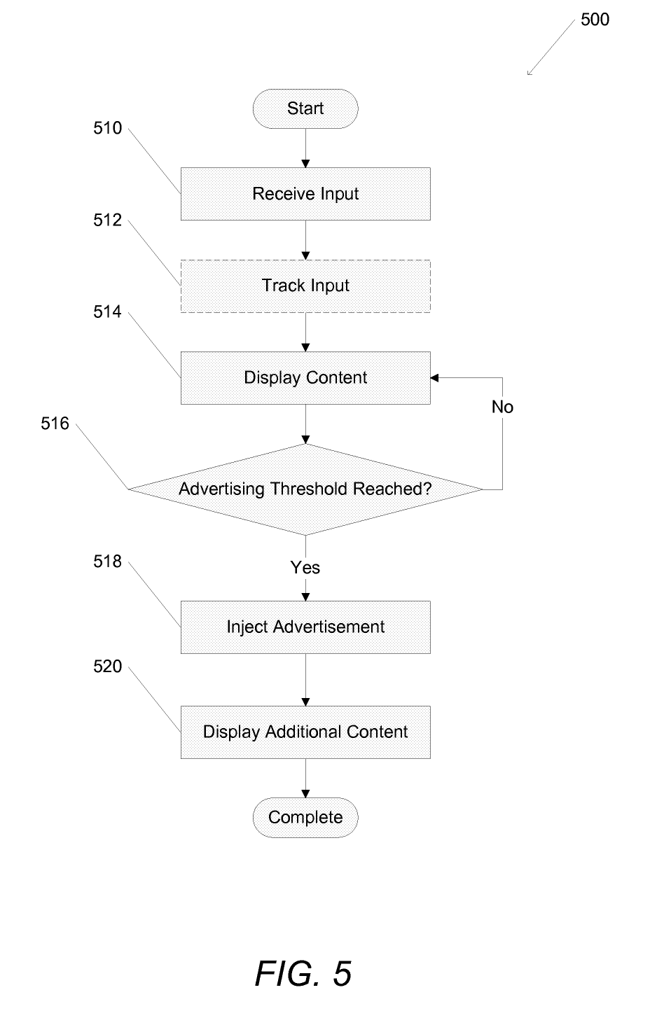

A variety of content viewed by users includes advertising content incorporated into the viewed content. By injecting inline advertising zones into the viewed content, additional advertising content can be displayed to users as the user browses long portions of content and/or content containing a smart footer allowing for the endless (or infinite) display of content by retrieving and including additional content to the previously displayed content. Content display devices in accordance with embodiments of the invention are configured to track the display of advertising content and/or additional content and dynamically inject additional inline advertising zones into the displayed content to present additional advertising content to the user. A process for injecting inline advertising zones into displayed content in accordance with an embodiment of the invention is conceptually illustrated in FIG. 5. The process 500 includes receiving (510) input. In a number of embodiments, input is tracked (512). Content is displayed (514). If an advertising threshold has been reached (516), an advertisement is injected (518) and additional content is displayed (520).

In a variety of embodiments, receiving (510) input, tracking (512) input, and/or displaying content (514) includes performing processes similar to those described above. In several embodiments, receiving (510) and/or tracking (512) utilizes processes similar to those described in U.S. patent application Ser. No. 13/792,855, the disclosure of which is incorporated by reference above. In many embodiments, tracking (512) input includes maintaining input metadata describing the tracked input. In several embodiments, the reached (516) advertising threshold includes determining the time elapsed since an inline advertising zone threshold was reached. In a number of embodiments, the reached (516) advertising threshold includes determining the amount of content that has been retrieved and/or displayed since the last inline advertising zone and/or advertising content was displayed. Other advertising thresholds can be utilized as appropriate to the requirements of specific applications in accordance with embodiments of the invention. In several embodiments, injecting (518) an advertisement includes incorporating an inline advertising zone and/or advertising content into additional content being requested and/or retrieved. In a number of embodiments, injecting (518) an inline advertising zone and/or advertising content includes modifying an object model associated with the displayed (514) content to incorporate the injected (518) content. In several embodiments, injecting (518) an inline advertising zone and/or advertising content includes modifying the markup or other data associated with the web page utilized in the rendering of the displayed (514) content. In a variety of embodiments, an inline interstitial advertisement is injected (518). In many embodiments, additional content and/or the injected (518) advertising content is displayed (520) utilizing processes similar to those described above.

A specific process for injecting inline advertising zones into displayed content is described above with respect to FIG. 5; however, any number of processes, including those that display advertising content other than inline interstitial advertisements, can be utilized in accordance with embodiments of the invention.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A content display device, comprising:
a processor;
memory connected to the processor and configured to store a content display application;
a network interface connected to the processor and configured to receive web page data;
an input device connected to the processor and configured to receive input data; and
a display connected to the processor and configured to display content;
wherein the content display application configures the processor to:
receive web page data using the network interface, where the web page data includes a plurality of pieces of content data and at least one script;
receive advertising content using the network interface;
generate an object model using the web page data;
render the received web page data using the object model, where the rendered web page data comprises displayable content and an inline advertising zone within the displayable content, where the inline advertising zone comprises an inline advertising zone threshold;
display a portion of the rendered web page data using the display;
receive input using the input device;
display a second portion of the rendered web page data using the display based on the received input;
identify when the inline advertising zone is within the inline advertising zone threshold using at least one of the at least one script, where the advertising zone threshold is based on the position of the inline advertising zone within the displayed portion of the rendered web page data;
modify the object model to include the advertising content in the displayed content based on the inline advertising zone;
re-render the received web page data using the updated object model, where the re-rendered web page data includes the advertising content; and
display the re-rendered web page data using the display.

2. The system of claim 1, wherein the advertising content comprises an inline interstitial advertisement, where an inline interstitial advertisement is configured to occupy the display of the content display device in a manner such that the inline interstitial advertisement is the focal point of the rendered web page data and the remaining content is de-emphasized from view.

3. The system of claim 1, wherein the content display application further configures the processor to receive advertising content from an advertising source separate and remote from the content display device.

4. The system of claim 1, wherein the content display application further configures the processor to display an advertising placeholder associated with the inline advertising zone, where the advertising placeholder is configured to provide an indication that advertising content will be displayed.

5. The system of claim 4, wherein the advertising placeholder comprises the received advertising content.

6. The system of claim 1, wherein the content display application further configures the processor to:
request additional content from a content source separate and remote from the content display device;
receive the additional content from the content source;
modify the object model to incorporate the received additional content;
re-render the received web page data using the modified object model; and
display the re-rendered web page data including the additional content.

7. The system of claim 6, wherein the content display application further configures the processor to:
generate input metadata based on the received input;
determine if an advertising threshold is reached based on the input metadata; and
inject an additional inline advertising zone into the object model based on the generated input metadata when the advertising threshold is reached.

8. The system of claim 7, wherein:
the input metadata is based on the time associated with identifying when the inline advertising zone is within the inline advertising zone threshold; and
the content display application further configures the processor to:
determine the time elapsed between the request for additional content and the recorded time; and
inject the additional inline advertising zone based on the determined time elapsed.

9. The system of claim 7, wherein:
the input metadata is based on the number of requests for additional content; and
the content display application further configures the processor to inject the additional inline advertising zone based on the number of requests for additional content.

10. The system of claim 1, wherein the content display application further configures the processor to:
measure the time elapsed since the re-rendered web page data was displayed; and
receive additional input using the input device when the measured time elapsed exceeds a time threshold associated with the advertising content, where the time threshold indicates a minimum amount of time the advertising content should be displayed using the display device.

11. A method for displaying content having inline advertising zones, comprising:
receiving web page data using a content display device, where the web page data includes a plurality of pieces of content data, at least one inline advertising zone, and at least one script, where the inline advertising zone comprises an inline advertising zone threshold;
receiving advertising content using the content display device;
generating an object model based on the web page data using the content display device;
rendering the received web page data based on the object model using the content display device, where the rendered web page data comprises displayable content and an inline advertising zone within the displayable content;
displaying a portion of the rendered web page data using the content display device;
receiving input using the content display device;
displaying a second portion of the rendered web page data using the content display device based on the received input;
identifying when the inline advertising zone is within the inline advertising zone threshold based at least one of the at least one script using the content display device, where the advertising zone threshold is based on the position of the inline advertising zone within the displayed portion of the rendered web page data;
modifying the object model to include the advertising content in the displayed content based on the inline advertising zone using the content display device;
re-rendering the received web page data based on the updated object model using the content display device, where the re-rendered web page data includes the advertising content; and
displaying the re-rendered web page data using the content display device.

12. The method of claim 11, wherein the advertising content comprises an inline interstitial advertisement, where an inline interstitial advertisement is configured to occupy the display of the content display device in a manner such that the inline interstitial advertisement is the focal point of the rendered web page data and the remaining content is de-emphasized from view.

13. The method of claim 11, further comprising receiving advertising content from an advertising source separate and remote from the content display device using the content display device.

14. The method of claim 11, further comprising displaying an advertising placeholder associated with the inline advertising zone using the content display device, where the advertising placeholder is configured to provide an indication that advertising content will be displayed.

15. The method of claim 14, wherein the advertising placeholder comprises the received advertising content.

16. The method of claim 11, further comprising:
requesting additional content from a content source separate and remote from the content display device using the content display device;
receiving the additional content from the content source using the content display device;
modifying the object model to incorporate the received additional content using the content display device;
re-rendering the received web page data based the modified object model using the content display device; and
displaying the re-rendered web page data including the additional content using the content display device.

17. The method of claim 16, further comprising:
generating input metadata based on the received input using the content display device;
determining if an advertising threshold is reached based on the input metadata using the content display device; and
injecting an additional inline advertising zone into the object model based on the generated input metadata when the advertising threshold is reached using the content display device.

18. The method of claim 17, further comprising:
determining the time elapsed between the request for additional content and the recorded time using the content display device, where the input metadata is based on the time associated with identifying when the inline advertising zone is within the inline advertising zone threshold; and
injecting the additional inline advertising zone based on the determined time elapsed using the content display device.

19. The method of claim 17, further comprising injecting the additional inline advertising zone based on the number of requests for additional content using the content display device, where the input metadata is based on the number of requests for additional content.

20. The method of claim 11, further comprising:
measuring the time elapsed since the re-rendered web page data was displayed using the content display device; and
receiving additional input using the content display device when the measured time elapsed exceeds a time threshold associated with the advertising content, where the time threshold indicates a minimum amount of time the advertising content should be displayed using the display device.
